(19) United States
(12) Patent Application Publication
(10) Pub. No.: US 2006/0252483 A1
(43) Pub. Date: Nov. 9, 2006

(54) Instant-win contest with physical entry mode

(76) Inventors: John W. Avery, Newnan, GA (US); Brian J. Westendorf, Seattle, WA (US)

Correspondence Address: LEE & HAYES, PLLC, 421 W. RIVERSIDE AVE, STE 500, SPOKANE, WA, 99201, US

(21) Appl. No.: 11/115,944

(22) Filed: Apr. 26, 2005

(51) Int. Cl. A63F 13/00

(52) U.S. Cl. 463/16; 463/42

(57) ABSTRACT

A physical entry mode is enabled for instant-win contests. In a described embodiment, a contest offers primary electronic entry modes that provide real-time communication for entry submission and award notification. An alternative physical entry mode does not provide real-time communications capabilities. In a described implementation, an historical sampling of received physical entries is taken in order to calculate an expected frequency of physical entry arrival. A physical entry prize-checking interval is determined responsive to the expected frequency of physical entry arrival. During the instant-win contest, received physical contest entries are selected from prize availability consideration at a given interval. The given interval is related to the physical entry prize-checking interval. In another described implementation, a prize generator randomly makes prizes from a total prize set available for winning throughout a contest's duration. Once made available, a prize may be won by a physical or an electronic contest entry.

### TECHNICAL FIELD

This disclosure relates in general to contest management and in particular, by way of example but not limitation, to enabling a physical entry mode for instant-win contests.

### BACKGROUND

Contests are often used in marketing for advertising purposes and to promote excitement or “buzz” about a product or service. Contests can also be used to educate consumers about the existence of products and services as well as the manner of using them. One popular contest type is the instant-win contest.

Instant-win contests are especially popular with marketers because such contests are especially popular with consumers. Consumers enjoy and often prefer instant-win contests because of the immediate gratification aspect of learning essentially instantly whether a contest entry has resulted in a win. With a contest that is not designed to be instant-win, a consumer contest entrant must often wait days, weeks, or even longer to receive a win-loss notification. With an instant-win contest, on the other hand, shortly after a contest entrant provides a contest entry to contest infrastructure, the contest entrant receives a notification of a win or a loss from the contest infrastructure.

Unfortunately, instant-win contests can be difficult to implement under the constraints of ensuring a rapid win-loss notification in conjunction with an indeterminate number of possible entries. Conducting instant-win contests is even more difficult when contest rules permit the submission of physical entries.

Accordingly, there is a need for schemes, mechanisms, techniques, etc. that can enable or facilitate the conducting of instant-win contests that offer a physical entry mode.

### SUMMARY

A physical entry mode is enabled in the context of an instant-win contest. In a described embodiment, a contest offers primary entry modes that are electronic. Examples of electronic entry modes include an interactive voice response (IVR) entry mode, a short message service (SMS) entry mode, a web entry mode, an email entry mode, and so forth. Electronic entry modes provide real-time communications for entry submission and win-loss notification. Alternative entry modes, such as a physical entry mode, often do not provide real-time communications capabilities.

In a described implementation, an historical sampling of received physical entries is taken in order to calculate an expected frequency of physical contest entry arrival. A physical entry prize-checking interval is determined responsive to the expected frequency of physical contest entry arrival. During the instant-win contest, received physical contest entries are selected for prize availability consideration at a given interval. The given interval is related to the determined physical entry prize-checking interval and may be fixed or random. In another described implementation, a prize generator randomly makes prizes from a total prize set available for winning throughout a contest's duration. Once made available, a prize may be won by a physical contest entry or an electronic contest entry.

Other method, system, approach, apparatus, device, media, procedure, API, arrangement, etc. implementations are described herein.

### BRIEF DESCRIPTION OF THE DRAWINGS

The same numbers are used throughout the drawings to reference like and/or corresponding aspects, features, and components.

FIG. 1 is a block diagram of an example contest environment illustrating multiple entry modes, multiple entry types, and a contest management infrastructure.

FIG. 2 is a block diagram illustrating example entry delivery channels and an example contest management infrastructure having a contest manager.

FIG. 3 is a block diagram of an example contest manager.

FIG. 4 is a flow diagram that illustrates an example of a method for generating prizes for a prize pool.

FIG. 5 is a flow diagram that illustrates an example of a method for handling entries received via an electronic delivery channel.

FIG. 6 is a flow diagram that illustrates a first part of an example method for handling physical entries received via a physical delivery channel.

FIG. 7 is a flow diagram that illustrates a second part of the example method for handling physical entries received via a physical delivery channel.

### DETAILED DESCRIPTION

### Introduction

As described above, instant-win contests can be difficult to conduct or implement under the constraint of ensuring a rapid win-loss notification, especially because the total number of possible entries is unknown. Furthermore, the conduction of instant-win contests is even more difficult when physical entries are permitted in accordance with contest rules.

For example, contest management infrastructure is usually required to handle the simultaneous or nearly simultaneous submission of a virtually unlimited number of entries. Not only is this demanding from a hardware/software and organizational perspective, it can also exhaust a finite set of prizes long before the contest official terminates. Moreover, laws and other possible legal constraints affecting the conducting of contests may require an alternative form or mode of entry, such as contest entry submission by standard mail. Integrating the submission of physical entries so as to elevate them to approximately the same level as real-time electronic entries can be particularly problematic.

To alleviate concerns of prematurely exhausting a finite prize set, the offering of prizes can be metered. In a described implementation, prizes are offered on a random basis responsive to the total number of prizes to be awarded and the planned contest duration. Specifically, prizes are added to a prize pool at random times. After being added to the prize pool, the next contest entry under consideration is awarded the prize.

In another described implementation, physical entries are accommodated in an instant-win contest environment. Physical entries can include, for example, letters, post cards, paper entry forms, and so forth. Using an historical sampling, the expected (e.g., average) arrival frequency of physical entries is calculated. An interval that is established responsive to the expected arrival frequency is utilized to determine when to check the prize pool on behalf of received physical entries.

### Example Implementations

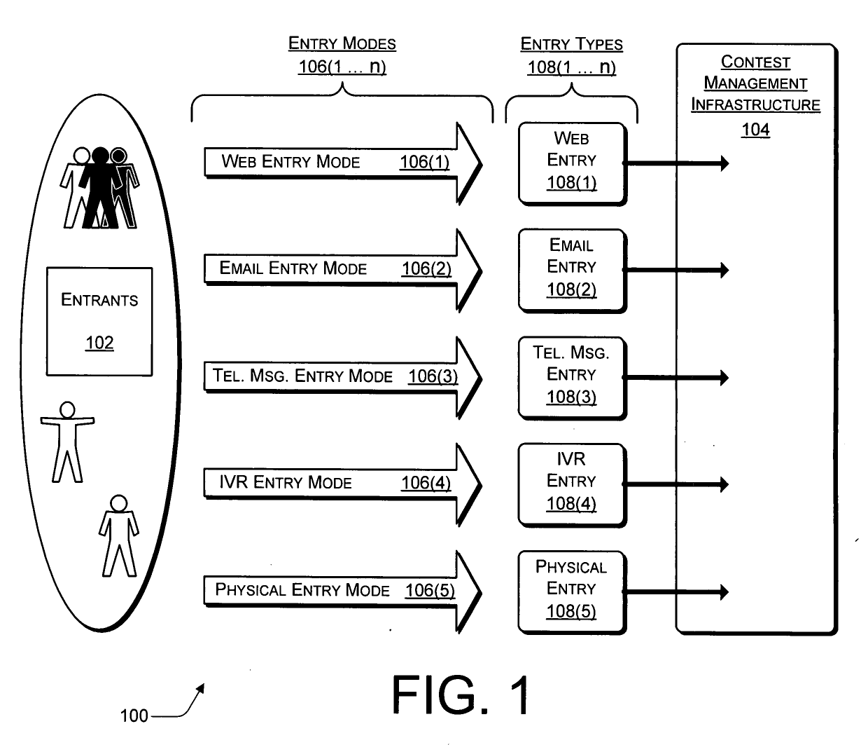

FIG. 1 is a block diagram of an example contest environment 100 illustrating multiple entry modes 106, multiple entry types 108, and a contest management infrastructure 104. Generally, contest environment 100 includes multiple contest entrants 102, “n” different entry modes 106(1 . . . n), and “n” different entry types 108(1 . . . n), as well as contest management infrastructure 104.

In a described implementation, contest management infrastructure 104 establishes and provides infrastructure to run a contest, usually in accordance with an associated set of rules (e.g., contest regulations, guidelines, etc.). Entrants 102 are empowered to submit contest entries of any stipulated entry type 108 and using any stipulated entry mode 106. Although five different entry modes 106(1-5) and five different entry types 108(1-5) are explicitly illustrated in FIG. 1, fewer or more than five such entry modes 106 and entry types 108 may actually be implemented by any given contest management infrastructure 104 and associated rules set.

Typically, each entry mode 106 has a corresponding entry type 108. By way of example only, the following five mode-entry pairs are shown as being part of contest environment 100 and as being offered by contest management infrastructure 104. A web entry 108(1) corresponds to a web entry mode 106(1). An email entry 108(2) corresponds to an email entry mode 106(2). A telephone message entry 108(3) corresponds to a telephone message entry mode 106(3). An interactive voice response (IVR) entry 108(4) corresponds to an IVR entry mode 106(4). A physical entry 108(5) corresponds to a physical entry mode 106(5).

Example manners for submitting entry types 108(1-5) in accordance with corresponding respective entry modes 106(1-5) are described as follows. A web entry 108(1) may be submitted by entering information at a web site using a browser. An email entry 108(2) may be submitted by sending an email having appropriate information to an email address that is stipulated by the rules. A telephone message entry 108(3) may be submitted with a short message service (SMS), a wireless application protocol (WAP) or other wireless protocol, and so forth. An IVR entry 108(4) may be submitted with a wireless or wired phone using a keypad or voice input to respond to interactive voice prompts. A physical entry 108(5) may be submitted as a letter, a postcard, an entry form, etc. by way of mail, courier, and so forth.

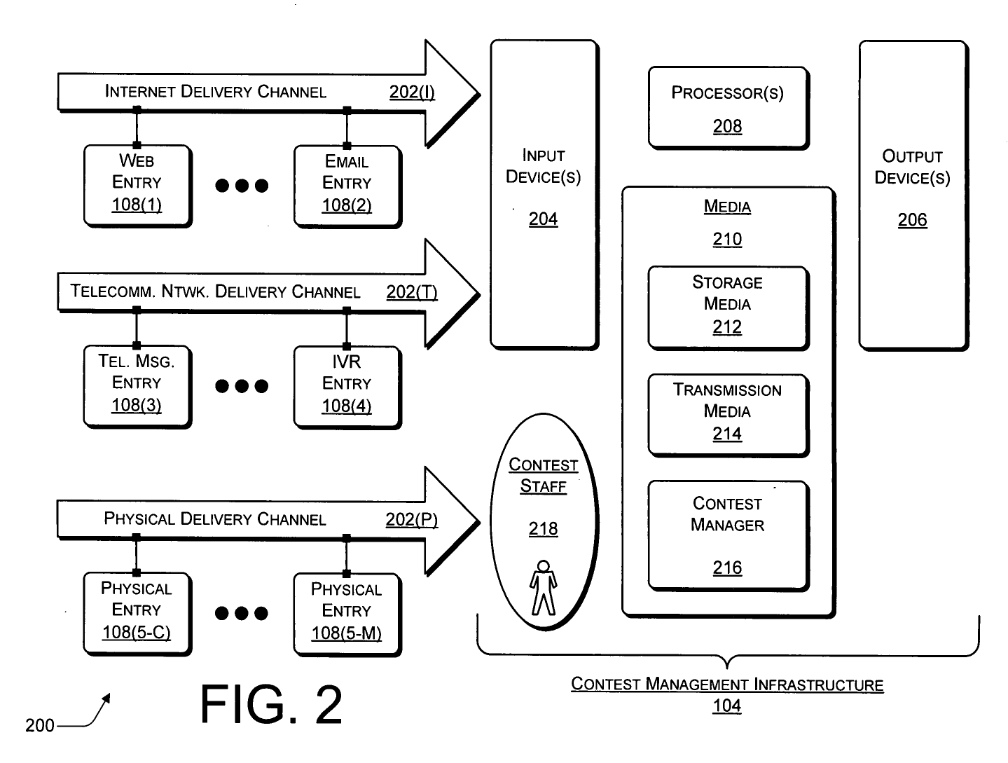

FIG. 2 is a block diagram illustrating example entry delivery channels 202 and an example contest management infrastructure 104 having a contest manager 216. As illustrated, there are three delivery channels 202(I), 202(T), and 202(P) that are providing contest entries 108 to contest management infrastructure 104. Multiple components 204-218 of contest management infrastructure 104 are also shown.

The three example delivery channels 202 are: an internet delivery channel 202(I), a telecommunications network delivery channel 202(T), and a physical delivery channel 202(P). Although three different delivery channels 202 are explicitly illustrated in FIG. 2, fewer or more than three such entry delivery channels 202 may alternatively be enabled by a given contest management infrastructure 104.

Internet delivery channel 202(I) enables contest entries 108 to be submitted to contest management infrastructure 104 via the internet and/or one or more other computer-based networks. Examples of internet-related entries include a web entry 108(1), an email entry 108(2), and so forth. Hence, internet delivery channel 202(I) embraces a web entry mode 106(1) and/or an email entry mode 106(2).

Telecommunications network delivery channel 202(T) enables contest entries 108 to be submitted to contest management infrastructure 104 via one or more telecommunications networks. The telecommunications networks may be wireless and/or wired. Examples of telecommunications-related entries include a telephone message entry 108(3), an IVR entry 108(4), and so forth. Hence, telecommunications network delivery channel 202(T) embraces a telephone message entry mode 106(3) and/or an IVR entry mode 106(4).

Physical delivery channel 202(P) enables contest entries 108 to be submitted to contest management infrastructure 104 via a physical route. Examples of physical-related entries include a physical entry 108(5-C) that is delivered by courier, a physical entry 108(5-M) that is delivered by a mail service, and so forth. In this context, courier physical delivery may include hand delivery by an entrant 102 as well as by a standard courier service or other individual, and mail service physical delivery may include delivery by any public or private mail service (e.g., United States Postal Service (USPS), Federal Express (FedEx), Universal Parcel Service (UPS), etc.). Hence, physical delivery channel 202(P) embraces at least physical entry mode 106(5).

It should be understood that entries 108 and delivery channels 202 are not limited to the examples specifically illustrated in FIG. 2 and described herein above. For instance, an actual entry 108 may be propagated via more than one delivery channel 202 between an entrant 102 (of FIG. 1) and contest management infrastructure 104. For example, a web entry 108(1) may initially travel over a telecommunications network prior to migrating to an internet. Also, a facsimile contest entry (not explicitly shown) may be submitted via an internet delivery channel 202(I) and/or a telecommunications network delivery channel 202(T). When relevant from the perspective of contest management infrastructure 104, a delivery channel 202 of a contest entry 108 may be determined by the last delivery channel 202 on which the contest entry 108 propagates prior to its arriving at contest management infrastructure 104.

In a described implementation, contest management infrastructure 104 includes the following components: one or more input devices 204, at least one processor 208, one or more media 210, and one or more output devices 206. The afore-mentioned components may be realized, for example, as one or more computers that are coupled to at least one internet and/or at least one telecommunications network. Contest management infrastructure 104 may also include contest staff 218. As illustrated, media 210 includes storage media 212, transmission media 214, and a contest manager 216.

Input devices 204 enable contest management infrastructure 104 to accept input from entrants 102, contest staff 218, and so forth. Input devices 204 can include mice, keyboards, and other manual input devices. Input devices 204 can also include a modem, a network interface card (NIC), a router, a switch, and so forth. Thus, those contest entries 108 that are being submitted via internet delivery channel 202(I) or telecommunications network delivery channel 202(T) may arrive and be accepted by one or more input devices 204.

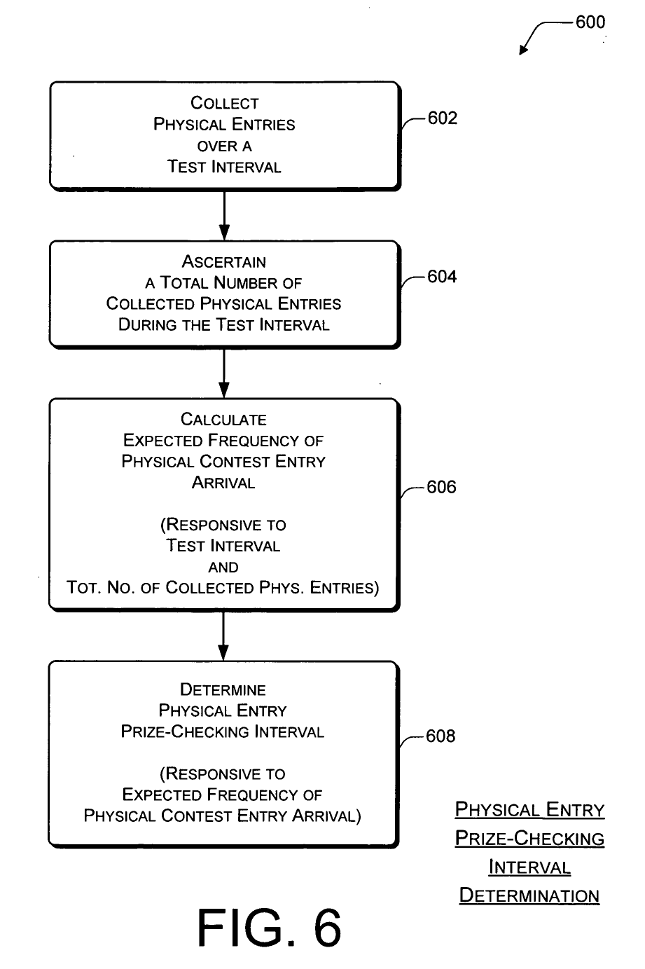

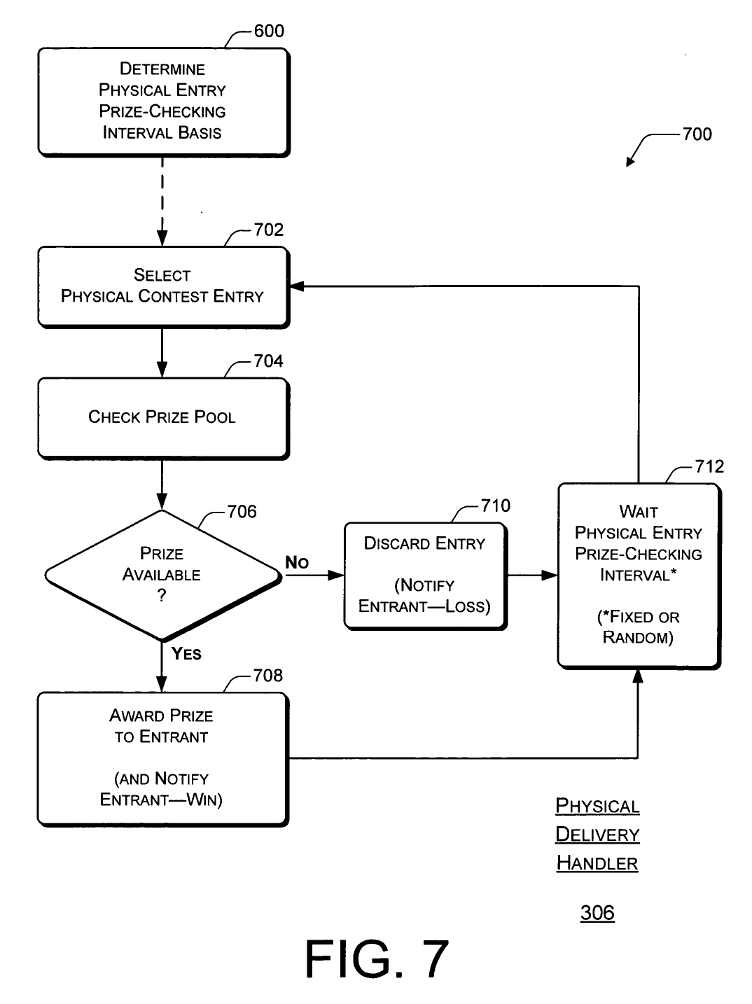

With physical delivery channel 202(P) on the other hand, physical entries 108(5) may be accepted by contest staff 218. For example, for full record keeping, contest staff 218 may receive physical entries 108(5) by mail or courier (e.g, from a mailbox or courier delivery receptacle if not actually by hand). Contest staff 218 may number each physical entry 108(5) in the order of arrival/receipt for subsequent processing. This subsequent processing is described further herein below with particular reference to FIGS. 6 and 7.

Alternatively, physical entries 108(5) that are arriving via a physical delivery channel 202(P) may be processed automatically using electromechanical technology. By way of example, physical entries 108(5) may be received by a machine such as a postcard mail processing machine or similar. The electromechanical machine may also be capable of reading physical entries 108(5), including entrant identification, a vote, contest-related information, some combination thereof, and so forth. If physical entries 108(5) are to be numbered, the numbering may be performed manually by contest staff 218 or by the processing machine. In such an automatic implementation, input devices 204 may also comprise a machine that processes physical entries 108(5). In the manual implementation, a receptacle for physical entries 108(5) may also be an input device 204.

Media 210 includes storage media 212 and transmission media 214. Storage media 212 may be realized as volatile or nonvolatile media, removable or non-removable media, some combination thereof, and so forth. Examples include optical and electromagnetic disk drives and arrays thereof, random access memory (RAM), flash memory, and so forth. Transmission media 214 may be realized as any wireless or wired media that is capable of supporting modulated data signals that are being communicated, as well as devices that interface therewith. Examples include wires, routers, etc.; fiber optics, switches, etc.; antennas; propagating electromagnetic signals; and so forth.

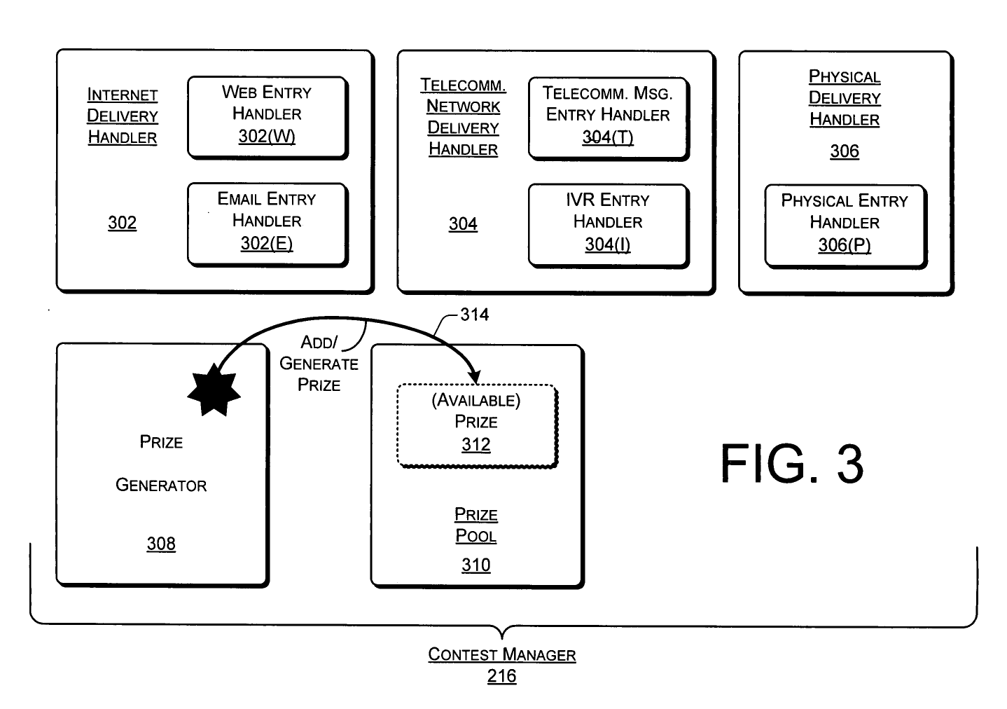

Generally, media 210 includes processor-executable instructions. These processor-executable instructions are executable by processor(s) 208 to effectuate those functions of contest management infrastructure 104 that are described herein, as well as other functions. By way of example, media 210 includes contest manager 216, which may comprise processor-executable instructions. Contest manager 216 may be realized as hardware, software, firmware, some combination thereof, and so forth. Contest manager 216 is described further herein below with particular reference to FIG. 3.

Output devices 206 enable contest management infrastructure 104 to provide output to entrants 102, contest staff 218, and so forth. Output devices 206 can include monitors, printers, and other human-oriented output devices. Output devices 206 can further include a modem, a NIC, a router, a switch, and so forth. Thus, at least for those contest entries 108 that are submitted via internet delivery channel 202(I) or telecommunications network delivery channel 202(T), win-loss notifications may be sent from contest management infrastructure 104 by one or more output devices 206 to associated entrants 102.

It should be noted that there may be overlap between and among input devices 204, media 210, and output devices 206. For example, a network interface device may be capable of receiving contest entries 108 as input, providing win-loss notifications in response thereto as output, and communicating processor-executable instructions as electromagnetic data signals across a transmission medium 214.

Thus, implementations for enabling a physical entry mode with instant-win contests may be described in the general context of processor-executable instructions. Generally, processor-executable instructions include routines, programs, protocols, objects, functions, interfaces, components, data structures, etc. that perform and/or enable particular tasks and/or implement particular abstract data types. Realizations for enabling a physical entry mode with instant-win contests, as described in certain implementations herein, may also be practiced in distributed processing environments where tasks are performed by remotely-linked processing devices that are connected through a communications link and/or network. Especially but not exclusively in a distributed computing environment, processor-executable instructions may be located in separate storage media, executed by different processors, and/or propagated over transmission media.

FIG. 3 is a block diagram of an example contest manager 216. As illustrated, contest manager 216 includes a number of modules. These modules include: an internet delivery handler 302, a telecommunications network delivery handler 304, a physical delivery handler 306, a prize generator 308, and a prize pool 310.

In a described implementation, internet delivery handler 302 is capable of handling those contest entries 108 that are received via internet delivery channel 202(I). Internet delivery handler 302 includes a web entry handler 302(W) and an email entry handler 302(E). Web entry handler 302(W) is adapted to handle web entries 108(1) that are received via web entry mode 106(1). Email entry handler 302(E) is adapted to handle email entries 108(2) that are received via email entry mode 106(2). Although telecommunications network delivery handler 304 is illustrated as having the capacity to handle both telecommunications message and IVR entry modes 106(3) and 106(4), it may alternatively have one or the other.

In a described implementation, telecommunications network delivery handler 304 is capable of handling those contest entries 108 that are received via telecommunications network delivery channel 202(T). Telecommunications network delivery handler 304 includes a telecommunications message entry handler 304(T) and an IVR entry handler 304(I). Telecommunications message entry handler 304(T) is adapted to handle telecommunications message entries 108(3) that are received via telecommunications message entry mode 106(3). IVR entry handler 304(I) is adapted to handle IVR entries 108(4) that are received via IVR entry mode 106(4). Although internet delivery handler 302 is illustrated as having the capacity to handle both web and email entry modes 106(1) and 106(2), it may alternatively have one or the other.

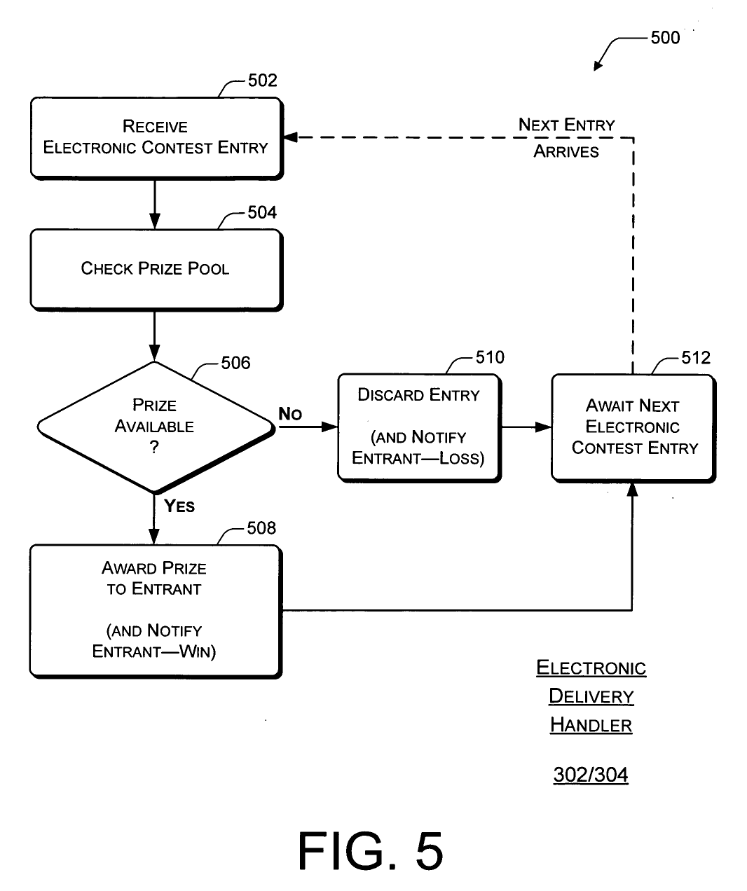

By way of example, it is given that an SMS text message is received as a telecommunications message entry 108(3) via a telecommunications message entry mode 106(3). The message is received, for instance, through a wireless network. Evaluation of the win-loss status of the telecommunications message entry 108(3) is the responsibility of telecommunications message entry handler 304(T). Consequently, the telecommunications message entry 108(3) is routed through telecommunications network delivery handler 304 to telecommunications message entry handler 304(T) for consideration of its win-loss status. An example implementation for this consideration and/or evaluation is described further herein below with particular reference to FIG. 5.

In a described implementation, physical delivery handler 306 is capable of handling those contest entries 108 that are received via physical delivery channel 202(P). Physical delivery handler 306 includes a physical entry handler 306(P). Physical entry handler 306(P) is adapted to handle physical entries 108(5) that are received via physical entry mode 106(5).

Generally, modules for contest entry handlers may be organized in a multitude of alternative manners. For example, there may be a single handler for contest entries regardless of entry type 108 or entry mode 106. Also, each individual entry handler 302(W), 302(E), 304(T), 304(I), and 306(P) may operate independently of any delivery handler 302, 304, or 306 (i.e., an example implementation may include no independently identifiable delivery handler modules or only one delivery handler module for multiple delivery channels). If delivery handlers exist and there is a dependency between delivery handlers and entry handlers, then overlapping functions may be shared. For example, interaction with internet protocols may be accomplished by internet delivery handler 302 on behalf of web entry handler 302(W) and email entry handler 302(E). Other combinations and permutations of modules for contest manager 216 are possible.

Physical delivery handler 306 may optionally include instructions for operating an electromechanical apparatus for receiving and/or processing physical entries 108(5). Also, if physical delivery handler 306 extends beyond media 210, physical delivery handler 306 may comprise all or part of such an electromechanical apparatus. An example implementation for the processing, consideration, and/or evaluation of physical entries 108(5) is described further herein below with particular reference to FIGS. 6 and 7.

Prize generator 308 is capable of generating prizes to make them available to be awarded. Prize generator 308 is adapted to randomly add a prize (as indicated by arrow 314) to prize pool 310 in a manner that approximately (e.g., stochastically) meters the total set of available prizes such that prizes can be awarded or won throughout a contest's duration. In other words, prize generator 308 is adapted to randomly make prizes 312 available for winning at prize pool 310 but to make them available such that the total set of prizes is not likely to be exhausted until approximately at the planned time of conclusion of the contest.

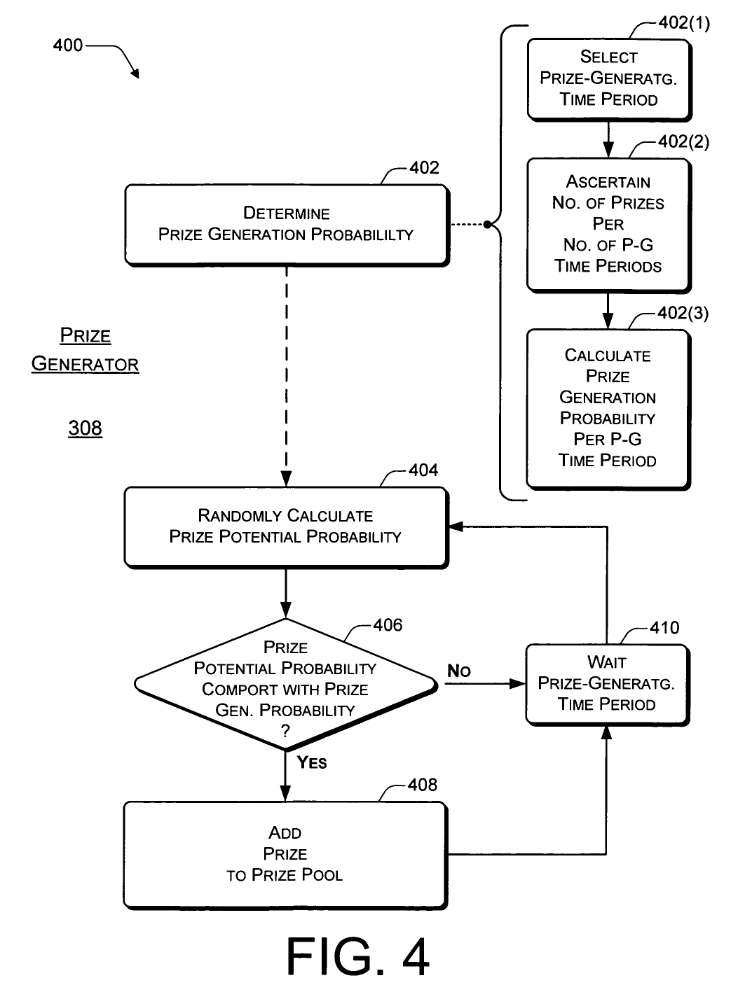

Prize pool 310 is capable of holding available prizes 312 until won by an incoming contest entry 108 as determined by internet delivery handler 302, telecommunications network delivery handler 304, and/or physical delivery handler 306. Prizes 312 may be realized as some data structure that identifies a real-world prize by code or other identifier. An example operational implementation for prize generator 308, as well as an example of its interaction with prize pool 310, is described further herein below with particular reference to FIG. 4.

FIG. 4 is a flow diagram 400 that illustrates an example of a method for generating prizes for a prize pool. Flow diagram 400 includes five (5) “primary” blocks 402-410 and three “secondary” blocks 402(1)-402(3). Although the actions of flow diagram 400 may be performed in other environments and with a variety of hardware and software combinations, FIGS. 1-3 are used in particular to illustrate certain aspects and examples of the method. By way of example only, the actions of flow diagram 400 may be performed by a prize generator 308.

At block 402, a prize generation probability is determined. The three blocks 402(1), 402(2), and 402(3) illustrate actions for an example implementation of the action(s) of block 402. At block 402(1), a prize-generating time period is selected. At block 402(2), a number of prizes per a number of prize-generating time periods is ascertained. At block 402(3), a prize generation probability per prize-generating time period is calculated.

The actions of blocks 402(1)-402(3) are described further by way of the following hypothetical. It is desired that seven prizes be awarded over seven days and that a prize possibly be available for awarding each hour. Hence, the selected prize-generating time period is one hour for block 402(1). There are therefore seven prizes to be awarded over the 168 hours of seven days. Hence, the ascertained number of prizes per number of time periods is 7 prizes per 168 hours for block 402(2). The calculated prize generation probability per prize-generating time period is therefore 7/168=4.2% for block 402(3). Alternative techniques may be employed to determine the prize generation probability.

At block 404, a prize potential is randomly calculated. For example, a random number generator of some kind may be employed to randomly (including pseudo-randomly) produce a prize potential probability.

At block 406, the prize potential probability is compared to the prize generation probability to determine if the prize potential probability comports with the prize generation probability. For example, it may be determined if the prize potential probability is less than the prize generation probability.

With the hypothetical described above, a prize potential probability that is less than 4.2% results in an affirmative determination. In an alternative but equivalent implementation, if the prize generation probability is determined (at block 402) to be 95.8%, then the determination (at block 406) is if the prize potential probability exceeds the prize generation probability.

If the prize potential probability is determined to comport with the prize generation probability (i.e., an affirmative determination at block 406), then at block 408 a prize is added to the prize pool. For example, an identity of an available prize 312 may be added 314 to prize pool 310. If, on the other hand, the prize potential probability is determined to not comport with the prize generation probability (i.e., a negative determination at block 406), then at block 410 the method of flow diagram 400 waits (e.g., sleeps or pauses) for the prize-generating time period. After expiration of the prize-generating time period, flow diagram 400 continues at block 404. The prize-generating time period may also be randomized, for example, such that the expected average of the waiting periods at block 410 is approximately equal to the selected prize-generating time period of block 402(1).

FIG. 5 is a flow diagram 500 that illustrates an example of a method for handling entries received via an electronic delivery channel. Flow diagram 500 includes six (6) blocks 502-512. Although the actions of flow diagram 500 may be performed in other environments and with a variety of hardware and software combinations, FIGS. 1-3 are used in particular to illustrate certain aspects and examples of the method. By way of example only, the actions of flow diagram 500 may be performed by an electronic delivery handler 302/304.

Electronic contest entries 108 can comprise web entries 108(1), email entries 108(2), telecommunications message entries 108(3), IVR entries 108(4), and so forth. Thus, electronic contest entries 108 can correspond to a web entry mode 106(1), an email entry mode 106(2), a telecommunications message entry mode 106(3), an IVR entry mode 106(4), and so forth. For the example implementation described herein above with particular reference to FIG. 3, an internet delivery handler 302 and/or a telecommunications network delivery handler 304 is capable of handling electronic entries 108. Hence, an internet delivery handler 302 and/or a telecommunications network delivery handler 304 may perform the actions of flow diagram 500.

At block 502, an electronic contest entry is received for consideration. For example, electronic delivery handler 302/304 may receive a contest entry 108(1,2,3,4) via an internet delivery channel 202(I) or a telecommunications network delivery channel 202(T). Received contest entry 108 is then evaluated with regard to a win-loss status.

At block 504, a prize pool is checked. For example, electronic delivery handler 302/304 may check prize pool 310. At block 506, it is determined if a prize is available at the prize pool. For example, it may be determined if a prize 312 is available (e.g., present) within prize pool 310. If so, then at block 508 the prize is awarded to the entrant associated with the received electronic entry. For example, available prize 312 may be awarded to an entrant 102 that is associated with the contest entry 108 that is currently being considered. To fulfill the instant-win nature of the contest, the winning entrant may optionally be “instantly” notified of the win. For example, a winning entrant 102 may be notified of the win using the same entry mode 106 and/or delivery channel 202 of the submitted winning electronic contest entry 108.

If, on the other hand, no prize is available at the prize pool (as determined at block 506), then at block 510 the electronic contest entry is discarded. For example, the received and evaluated contest entry 108 may be discarded by deleting it or by moving it to long-term storage (e.g., it may be removed from further potential consideration for a prize, but possibly stored). To fulfill the instant-win nature of the contest, the losing entrant may optionally be “instantly” notified of the loss. For example, a losing entrant 102 may be so notified using the same entry mode 106 and/or delivery channel 202 of the submitted losing electronic contest entry 108. Alternatively, the absence of a response may serve to notify of losses.

At block 512, arrival of the next electronic contest entry is awaited. Upon arrival of the next electronic contest entry 108(1,2,3,4), the method of flow diagram 500 continues at block 502 so that the next arriving electronic contest entry 108 may be considered (e.g., evaluated for win-loss status).

FIG. 6 is a flow diagram 600 that illustrates a first part of an example method for handling physical entries received via a physical delivery channel. The first part involves a physical entry prize-checking interval determination. Flow diagram 600 includes four (4) blocks 602-608. Although the actions of flow diagram 600 may be performed in other environments and with a variety of hardware and software combinations, FIGS. 1-3 are used in particular to illustrate certain aspects and examples of the method.

By way of example only, the actions of flow diagram 600 may be performed by a physical delivery handler 306 that includes electromechanical components for automatically processing physical entries 108(5). Alternatively, the actions of flow diagram 600 may be performed by contest staff 218. The actions of flow diagram 600 may also be divided and shared between contest staff 218 and physical delivery handler 306.

At block 602, physical entries over a test interval are collected. For example, as physical entries 108(5) are received via at least one physical delivery channel 202(P), they are collected for a selected/predetermined test interval. For instance, for a contest that is to span several weeks, physical entries 108(5) may be collected for a test interval lasting one week. To enable physical entries 108(5) to be considered for or to compete for prizes throughout an official duration of an instant-win contest, physical entries may be accepted for a stipulated period prior to the official duration and then considered while the official duration is transpiring.

At block 604, a total number of physical entries that are collected during the test interval is ascertained. For example, the number of physical entries 108(5) that are collected during the predetermined test interval may be summed.

At block 606, an expected frequency of physical contest entry arrival is calculated responsive to the length of the test interval and the total number of collected physical entries. For example, an expected frequency of physical contest entry arrival may be calculated by dividing the summed total of collected physical entries 108(5) by the predetermined test interval. For instance, if the predetermined test interval lasts 24 hours and 96 physical entries 108(5) are collected, the expected frequency of physical contest entry arrival is 4 physical entries per hour (96/24=4). However, the expected frequency of physical contest entry arrival may generally be based on historical data and may thus be at least one of: an average rate of arrival during a test interval, an estimated rate of arrival during a test interval, a highest level of arrival during a test interval, some combination thereof, and so forth.

At block 608, a physical entry prize-checking interval is determined responsive to the expected frequency of physical contest entry arrival. For example, a physical entry prize-checking interval may be determined by inverting the expected frequency of physical contest entry arrival. In other words, the reciprocal or multiplicative inverse of the expected frequency of physical contest entry arrival is taken to determine the physical entry prize-checking interval. For instance, continuing the above example, 4 expected physical contest entries per hour equates to a ¼ hour physical entry prize-checking interval. Thus, a prize pool 310 may be checked every 15 minutes on behalf of a physical entry 108(5).

FIG. 7 is a flow diagram 700 that illustrates a second part of the example method for handling physical entries received via a physical delivery channel. The second part involves checking a prize pool on behalf of physical entries in accordance with a physical entry prize-checking interval. Flow diagram 700 includes six (6) blocks 702-712 plus a block 600. Although the actions of flow diagram 700 may be performed in other environments and with a variety of hardware and software combinations, FIGS. 1-3 are used in particular to illustrate certain aspects and examples of the method. By way of example only, the actions of flow diagram 700 may be performed by a physical delivery handler 306.

At block 600, a physical entry prize-checking interval basis is determined (e.g., to be fixed or random). For example, a fixed physical entry prize-checking interval basis may be determined as described herein above with particular reference to FIG. 6. Alternatively, the physical entry prize-checking interval basis may be randomized. For example, to introduce additional randomness, the physical entry prize-checking interval may be changed for each iteration such that it varies but is still on average expected to be approximately equal to a value determined by the fixed interval approach described above. Thus, if 900 physical contest entries are expected on a given day, the average value of the physical entry prize-checking interval, even after randomization, is approximately 1.6 minutes [(24 hours*60 minutes/hour)/(900 expected checkings)], but each specific interval may vary (e.g., from 0.1 to 5.0 minutes).

Such additional randomness also likely provides greater fairness to physical contest entries. For instance, if the physical entry prize-checking interval and the prize-generating time period (of FIG. 4) were out of synchronization, a contest in which there were frequent electronic entries might effectively exclude the physical contest entries from having a legitimate chance of winning without this additional randomness. Other randomization approaches may alternatively be employed.

At block 702, a physical contest entry is selected. As described above, arriving physical entries 108(5) may be marked or numbered chronologically upon arrival. Consequently, physical entries 108(5) may be selected for win-loss consideration in the order of arrival by physical delivery handler 306, for example by identifying them with the chronological numbering. Alternatively, a physical entry 108(5) may be randomly selected from a block of received physical entries 108(5). The block may comprise all physical entries 108(5) that have arrived, a set of physical entries 108(5) that arrived during a defined previous interval, and so forth.

At block 704, the prize pool is checked. For example, physical delivery handler 306 may check prize pool 310. At block 706, it is determined if a prize is available based on the checking. For example, physical delivery handler 306 may determine if an available prize 312 is present at prize pool 310.

If a prize is available, then at block 708 the prize is awarded to the entrant. For example, if a prize 312 is available at prize pool 310, the available prize 312 may be awarded to an entrant 102 that is associated with the physical entry 108(5) being considered. The winning entrant is also notified of the win. The notification may be effectuated via a physical delivery channel 202(P), or the associated entrant 102 may be notified by phone, email, and so forth.

If, on the other hand, it is determined (at block 706) that no prize is available, then at block 710 the physical entry being considered is discarded. The losing entrant may also be notified of the loss. However, because the losing physical entry 108(5) was submitted via a physical delivery channel 202(P) in an instant-win contest, the absence of notification may be used to effectively notify such entrants of a non-winning status.

At block 712, the method waits for the physical entry prize-checking interval. For example, (i) execution of physical delivery handler 306 may sleep or be suspended or (ii) execution of the remainder of flow diagram 700 may pause for a duration equal to the physical entry prize-checking interval. As indicated by the asterisk and as described further herein above, the physical entry prize-checking interval may be fixed or random. It should be understood that by adopting or utilizing accepted computer programming practices any of the modules described herein may sleep, be suspended, awaken, etc. for other ancillary reasons, which are often related to sharing and managing computer resources.

The devices, actions, aspects, features, functions, procedures, modules, data structures, components, etc. of FIGS. 1-7 are illustrated in diagrams that are divided into multiple blocks. However, the order, interconnections, interrelationships, layout, etc. in which FIGS. 1-7 are described and/or shown is not intended to be construed as a limitation, and any number of the blocks can be modified, combined, rearranged, augmented, omitted, etc. in any manner to implement one or more systems, methods, devices, procedures, media, apparatuses, APIs, arrangements, etc. for enabling a physical entry mode for an instant-win contest. Furthermore, although the description herein includes references to specific implementations (including example components in FIG. 3), the illustrated and/or described implementations can be implemented in any suitable hardware, software, firmware, or combination thereof and using any suitable coding language(s), communication protocol(s), delivery channel(s), entry mode(s), randomization mechanism(s), contest format(s), and/or interval determination approach(es), and so forth.

Although systems, media, devices, methods, procedures, apparatuses, techniques, schemes, approaches, procedures, arrangements, and other implementations have been described in language specific to structural, logical, algorithmic, and functional features and/or diagrams, it is to be understood that the invention defined in the appended claims is not necessarily limited to the specific features or diagrams described. Rather, the specific features and diagrams are disclosed as example forms of implementing the claimed invention.

What is claimed is:

1. One or more processor-accessible media comprising processor-executable instructions that, when executed, direct a device to perform actions comprising:
selecting a physical contest entry;
checking a prize pool to determine if a prize is available;
waiting a physical entry prize-checking interval that is determined responsive to an expected frequency of physical contest entry arrival; and
after the waiting action, repeating the action of selecting for another physical contest entry.

2. The one or more processor-accessible media as recited in claim 1, wherein the action of selecting further comprises at least one action of:
selecting a next physical contest entry from multiple physical contest entries that are chronologically ordered by time of receipt; or
selecting a next physical contest entry randomly.

3. The one or more processor-accessible media as recited in claim 1, comprising the processor-executable instructions that, when executed, direct the device to perform a further action comprising:
if a prize is determined to be available at the prize pool, awarding the available prize to an entrant associated with the selected physical contest entry.

4. The one or more processor-accessible media as recited in claim 3, comprising the processor-executable instructions that, when executed, direct the device to perform a further action comprising:
notifying the associated entrant of a winning status of the selected physical contest entry submitted by the associated entrant.

5. The one or more processor-accessible media as recited in claim 1, comprising the processor-executable instructions that, when executed, direct the device to perform a further action comprising:
if a prize is determined to not be available at the prize pool, discarding the selected physical contest entry.

6. The one or more processor-accessible media as recited in claim 1, comprising the processor-executable instructions that, when executed, direct the device to perform further actions comprising:
ascertaining a total number of collected physical contest entries during a test interval; and
calculating the expected frequency of physical contest entry arrival responsive to a duration of the test interval and the total number of collected physical contest entries.

7. The one or more processor-accessible media as recited in claim 1, comprising the processor-executable instructions that, when executed, direct the device to perform further actions comprising:
receiving an electronic contest entry;
checking the prize pool to determine if a prize is available for the electronic contest entry;
awaiting receipt of a next electronic contest entry; and
after the receipt of the next electronic contest entry, checking the prize pool to determine if a prize is available for the next electronic contest entry.

8. The one or more processor-accessible media as recited in claim 7, comprising the processor-executable instructions that, when executed, direct the device to perform further actions comprising:
if a prize is determined to be available at the prize pool for the electronic contest entry,
awarding the available prize to an entrant associated with the electronic contest entry; and
notifying the associated entrant of a winning status of the electronic contest entry using a same mode in which the electronic contest entry was submitted by the associated entrant.

9. The one or more processor-accessible media as recited in claim 1, comprising the processor-executable instructions that, when executed, direct the device to perform further actions comprising:
randomly calculating a prize potential probability;
determining if the prize potential probability comports with a prize generation probability; and
if the prize potential probability is determined to comport with the prize generation probability, adding a prize to the prize pool.

10. The one or more processor-accessible media as recited in claim 9, comprising the processor-executable instructions that, when executed, direct the device to perform a further action comprising:
if the prize potential probability is determined to not comport with the prize generation probability, waiting a prize-generating time period before repeating the action of randomly calculating.

11. The one or more processor-accessible media as recited in claim 10, comprising the processor-executable instructions that, when executed, direct the device to perform a further action comprising:
calculating the prize generation probability per the prize-generating time period responsive to a given number of prizes to be awarded over a predetermined number of prize-generating time periods.

12. The one or more processor-accessible media as recited in claim 1, wherein at least a portion of the processor-executable instructions comprise at least part of a contest manager program of contest management infrastructure.

13. A system for conducting a contest, the system comprising:
a prize generator that is adapted to randomly make prizes available at a prize pool;
a physical delivery handler that is capable of handling physical contest entries that are submitted for the contest, the physical delivery handler adapted to check if a prize is available at the prize pool on behalf of received physical contest entries at a physical entry prize-checking interval that is determined responsive to an expected frequency of physical contest entry arrival.

14. The system as recited in claim 13, wherein the system comprises one or more computers.

15. The system as recited in claim 13, wherein the prize generator is further adapted to add a prize to the prize pool if a prize potential probability comports with a prize generation probability.

16. The system as recited in claim 13, wherein the prize generator is further adapted to determine whether to add a prize to the prize pool every prize-generating time period; and wherein the prize generation probability is calculated responsive to the prize-generating time period and a total number of prizes to be awarded during the contest.

17. The system as recited in claim 13, further comprising:
an internet delivery handler that is capable of handling contest entries that are submitted for the contest via at least one internet.

18. The system as recited in claim 13, further comprising:
a telecommunications network delivery handler that is capable of handling contest entries that are submitted for the contest via at least one telecommunications network.

19. The system as recited in claim 13, wherein the expected frequency of physical contest entry arrival is calculated responsive to a test interval and a total number of physical contest entries that are collected during the test interval.

20. The system as recited in claim 19, wherein at least one of the expected frequency of physical contest entry arrival or the physical entry prize-checking interval is entered into the system manually.

21. The system as recited in claim 19, wherein the physical delivery handler includes an electromechanical device that is capable of processing received physical contest entries; and wherein at least one of the expected frequency of physical contest entry arrival or the physical entry prize-checking interval is determined at least partly automatically using the electromechanical device.

22. The system as recited in claim 13, further comprising at least one of:
a web entry handler that is adapted to handle contest entries that are received via a web entry mode;
an email entry handler that is adapted to handle contest entries that are received via an email entry mode;
a telecommunications message entry handler that is adapted to handle contest entries that are received via a telecommunications message entry mode; or
an interactive voice response (IVR) entry handler that is adapted to handle contest entries that are received via an IVR entry mode.

23. A method comprising:
collecting physical contest entries over a selected interval;
ascertaining a total number of the collected physical contest entries that are collected during the selected interval; and
determining a physical contest entry prize-checking interval responsive to the selected interval and the ascertained total number of collected physical contest entries.

24. The method as recited in claim 23, wherein the method is performed at least partially manually.

25. The method as recited in claim 23, wherein the method is performed at least partially automatically using an electromechanical device that is capable of processing the collected physical contest entries.

26. The method as recited in claim 23, further comprising:
utilizing the physical contest entry prize-checking interval to conduct a contest.

27. The method as recited in claim 26, wherein the utilizing comprises:
handling, in accordance with the physical contest entry prize-checking interval, physical contest entries that are received for the contest.

28. The method as recited in claim 27, wherein the handling comprises:
checking, in accordance with a given instance of the physical contest entry prize-checking interval, a prize pool on behalf of a given received physical contest entry to determine if an entrant is to be awarded a prize in the contest, the entrant associated with the given received physical contest entry during the given instance of the physical contest entry prize-checking interval.

29. The method as recited in claim 23, further comprising:
calculating an expected frequency of physical contest entry arrival responsive to the selected interval and the ascertained total number of collected physical contest entries;
wherein the determining comprises:
determining the physical contest entry prize-checking interval responsive to the calculated expected frequency of physical contest entry arrival.

30. The method as recited in claim 23, further comprising:
selecting a particular physical contest entry;
checking a prize pool to determine if a prize is available for the particular physical contest entry;
waiting the physical contest entry prize-checking interval; and
after the waiting, repeating the selecting and the checking for another physical contest entry.

31. The method as recited in claim 30, further comprising:
receiving an electronic contest entry;
checking the prize pool to determine if a prize is available for the electronic contest entry;
awaiting receipt of a next electronic contest entry; and
after the receipt of the next electronic contest entry, repeating the checking to determine if a prize is available for the next electronic contest entry.

32. The method as recited in claim 23, further comprising:
randomly calculating a prize potential probability;
determining if the prize potential probability comports with a prize generation probability; and
if the prize potential probability is determined to comport with the prize generation probability, adding a prize to the prize pool.

33. The method as recited in claim 32, further comprising:
if the prize potential probability is determined to not comport with the prize generation probability, waiting a prize-generating time period before repeating the randomly calculating.

34. A method comprising:
collecting physical contest entries over a selected test interval;
ascertaining a total number of the collected physical contest entries that are collected during the selected test interval;
determining a physical contest entry prize-checking interval responsive to the selected test interval and the ascertained total number of collected physical contest entries;
randomly calculating a prize potential probability;
determining if the prize potential probability comports with a prize generation probability;
if the prize potential probability is determined to comport with the prize generation probability, adding a prize to a prize pool;
selecting a particular physical contest entry;
checking the prize pool to determine if a prize is available for the particular physical contest entry;
waiting the physical contest entry prize-checking interval; and
after the waiting, repeating the selecting and the checking for another physical contest entry.

35. The method as recited in claim 34, further comprising:
if the prize potential probability is determined to not comport with the prize generation probability, waiting a prize-generating time period before repeating (i) the randomly calculating, (ii) the determining if the prize potential probability comports with the prize generation probability, and (iii) the adding that is conditioned on a determination that the prize potential probability comports with the prize generation probability.

36. The method as recited in claim 34, further comprising:
receiving an electronic contest entry;
checking the prize pool to determine if a prize is available for the electronic contest entry;
awaiting receipt of a next electronic contest entry; and
after the receipt of the next electronic contest entry, checking the prize pool to determine if a prize is available for the next electronic contest entry.

37. An arrangement for enabling a physical entry mode with an instant-win contest, the arrangement comprising:
prize generation means for stochastically generating prizes at a prize pool; and
physical entry means for handling physical entries that are submitted to the instant-win contest via a physical delivery channel, the physical entry means adapted to check for prize availability at the prize pool at an interval determined responsive to an expected frequency of physical entry arrival.

38. The arrangement as recited in claim 37, further comprising:
internet entry means for handling internet entries that are submitted to the instant-win contest via an internet delivery channel.

39. The arrangement as recited in claim 37, further comprising:
telecommunications network entry means for handling telecommunications network entries that are submitted to the instant-win contest via a telecommunications network delivery channel.

40. The arrangement as recited in claim 37, wherein the interval is fixed or random.

41. The arrangement as recited in claim 37, wherein the physical entry means comprises:
award means for awarding a prize to a physical entry under consideration when a prize is available at the prize pool.

42. The arrangement as recited in claim 37, wherein the physical entry means comprises:
calculation means for calculating the expected frequency of physical entry arrival responsive to a test interval and a total number of physical entries collected over the test interval; and
determination means for determining the interval, the interval comprising a physical entry prize-checking interval.

43. An apparatus that is capable of at least partially conducting an instant-win contest having multiple modes of entry, the multiple modes of entry including a physical entry mode and at least one electronic entry mode; the apparatus adapted to make prizes randomly available at a prize pool; wherein the apparatus is further adapted to check the prize pool at an interval that is determined responsive to a calculated frequency of physical contest entry arrival for prize availability on behalf of physical contest entries submitted via the physical entry mode.

44. The apparatus as recited in claim 43, wherein the apparatus comprises contest management infrastructure including at least one computing device.

45. The apparatus as recited in claim 44, wherein the physical contest entries comprise postcards.

46. The apparatus as recited in claim 43, wherein the calculated frequency of physical contest entry arrival comprises an expected frequency of physical entry arrival that is calculated responsive to historical data.

47. The apparatus as recited in claim 46, wherein the historical data comprises at least one of an average rate of arrival during a test interval, an estimated rate of arrival during a test interval, or a highest level of arrival during a test interval.

48. The apparatus as recited in claim 43, wherein the at least one electronic entry mode comprises at least one of a web entry mode, an email entry mode, a telephone message entry mode, or an interactive voice response (IVR) entry mode.

49. The apparatus as recited in claim 43, wherein the apparatus is further adapted to randomly calculate a prize potential probability and to add a prize to the prize pool if the randomly-calculated prize potential probability comports with a predetermined prize generation probability.

50. The apparatus as recited in claim 43, wherein the apparatus is further adapted to check the prize pool upon arrival of electronic contest entries for prize availability on behalf of the electronic contest entries submitted via the at least one electronic entry mode.
